(19) United States
(12) Patent Application Publication
(10) Pub. No.: US 2002/0130002 A1
(43) Pub. Date: Sep. 19, 2002

(54) Gas cup seal for magneto-rheological damper

(75) Inventors: Patrick Neil Hopkins, West Carrollton, OH (US); Frank M. Robinson, Oakwood, OH (US); Michael W. Hurtt, Waynesville, OH (US); William Charles Kruckemeyer, Beavercreek, OH (US); Michael L. Oliver, Xenia, OH (US)

Correspondence Address: Delphi Technologies Inc., Legal Staff, P.O. Box 5052, Mail Code 480-414-420, Troy, MI, 48007-5052, US

(73) Assignee: Delphi Technologies, Inc.

(21) Appl. No.: 09/809,455

(22) Filed: Mar. 15, 2001

(51) Int. Cl. F16F 9/53; F16F 9/36

(52) U.S. Cl. 188/267.2; 188/322.16

(57) ABSTRACT

A magneto-rheological (“MR”) damper having a gas cup that slidably moves within a damper body tube and isolates an MR fluid from a gas in one end of the damper body tube. The gas cup has a dynamic seal that comprises an MR fluid compatible O-ring located in a narrow O-ring groove disposed in an outer surface of the gas cup. The narrow O-ring groove is sized to reduce entrapment of abrasive magnetic particles in the MR fluid between the O-ring and an inner surface of the damper body tube. The O-ring groove has a free roll room of about less than 12%.

### FIELD OF THE INVENTION

The present invention relates to a magneto-rheological (MR) fluid damper, and more particularly, to a linearly-acting MR fluid damper suitable for vibration damping in a vehicle suspension system.

### BACKGROUND OF THE INVENTION

Magneto-rheological (MR) fluids are materials that respond to an applied magnetic field with a change in rheological behavior (i.e., change in formation and material flow characteristics). The flow characteristics of these MR fluids change several orders of magnitude within milliseconds when subjected to a suitable magnetic field. In particular, magnetic particles noncolloidally suspended in fluid align in chain-like structures parallel to the applied magnetic field increasing the viscous characteristics of the MR fluid.

Devices such as controllable dampers benefit from the controllable viscosity of MR fluid. For example, linearly-acting MR fluid dampers are used in vehicle suspension systems as vibration dampers. At low levels of vehicle vibration, the MR fluid damper lightly damps the vibration, providing a more comfortable ride, by applying a low magnetic field or no magnetic field at all to the MR fluid. At high levels of vehicle vibration, the amount of damping can be selectively increased. The controllable damper lends itself to integration in vehicle suspension systems that sense vehicle load, road surface condition, and driver preference for a stiffer suspension performance.

MR fluid dampers share a general design consideration with other types of dampers; in order to provide damping, an internal volume of the damper changes in one of two ways. First, twin tube linearly-acting dampers include two half-cylinders, with an outer tube sliding over an inner tube. Connected to the inner tube, a piston translates inside the volume of the combined two half-cylinders to provide the damping. The volume increases as the two halves translate longitudinally in opposite directions. Dampers of this type are often used in shock absorbers.

Second, other dampers change internal volume even with a monotube cylinder of fixed length. A piston translates inside of the cylinder to provide the damping. A piston rod connects to the piston and to the outside of the cylinder. As a larger portion of the piston rod is inserted into the cylinder, the internal volume available for fluid is decreased. Dampers of this type are often used in vehicle suspension struts.

The fluid in the damper, being incompressible, is not capable of accommodating these volume changes. Consequently, a compressible gas charge compensates for the changes in volume. Specifically, the gas charge is kept separate from the fluid with a gas cup so that gas does not change the damping response by coming into contact with the piston. The gas cup, and an upper portion of the cylinder filled with the gas charge, form a floating piston accumulator.

The gas cup has an O-ring contained within an annular groove, or gland, that seals to the interior of the cylinder to provide the fluid/gas separation. O-rings are inexpensive but provide an effective dynamic gas seal of the gas cup. However, the service life of O-rings is shorter than desired. The magnetic particles in the MR fluid are abrasive, tending to prematurely wear the O-ring, and leakage past the gas cup O-ring due to premature wear leads to a premature failure of the MR fluid damper.

Consequently, a significant need exists for an improved gas cup dynamic seal in an MR fluid damper.

### SUMMARY OF THE INVENTION

The present invention provides a dynamic seal for a gas cup of an MR fluid damper that has a substantially improved durability and service life. With the present invention, the average service life of the gas cup dynamic seal is more comparable to the average service life of other components in the MR fluid damper, and thus, the average service life of the MR fluid damper is thus substantially increased. Therefore, an MR fluid damper employing the gas cup seal of the present invention is especially useful in vehicle suspension systems where a long and reliable service life is at a premium. The dynamic seal of the present invention is achieved using known, inexpensive O-rings; and thus, the dynamic seal of the present invention does not increase the manufacturing costs of the MR fluid damper.

According to the principles of the present invention and in accordance with the described embodiment, the present invention provides a magneto-rheological (“MR”) damper having a closed damper body tube. A gas cup slidably moves within the damper body tube and isolates an MR fluid from a gas in one end of the damper body tube. A dynamic seal is formed in an outer surface of the gas cup and is in sealing contact with an inner surface of the damper body tube. The dynamic seal comprises an MR fluid compatible O-ring located in a narrow O-ring groove disposed in the outer surface of the gas cup. The narrow O-ring groove is sized to reduce entrapment of abrasive magnetic particles in the MR fluid between the O-ring and the inner surface of the damper body tube.

In one aspect of the invention, the O-ring groove has a free roll room of about less than 12%; and in another aspect of the invention, the O-ring groove has a free roll room of about 5-12%.

These and other objects and advantages of the present invention will become more readily apparent during the following detailed description taken in conjunction with the drawings herein.

### BRIEF DESCRIPTION OF THE DRAWINGS

The accompanying drawings, which are incorporated in and constitute a part of this specification, illustrate embodiments of the invention and, together with the general description of the invention given above and the detailed description of the embodiments given below, serve to explain the principles of the present invention.

FIG. 1 is a cross-sectional view of a magneto-rheological (MR) damper.

FIG. 2 is a cross-sectional view of a prior art gas cup of an MR fluid damper.

FIG. 3 is a cross-sectional view of a gas cup of the MR fluid damper of FIG. 1 consistent with aspects of the invention.

### DETAILED DESCRIPTION OF THE INVENTION

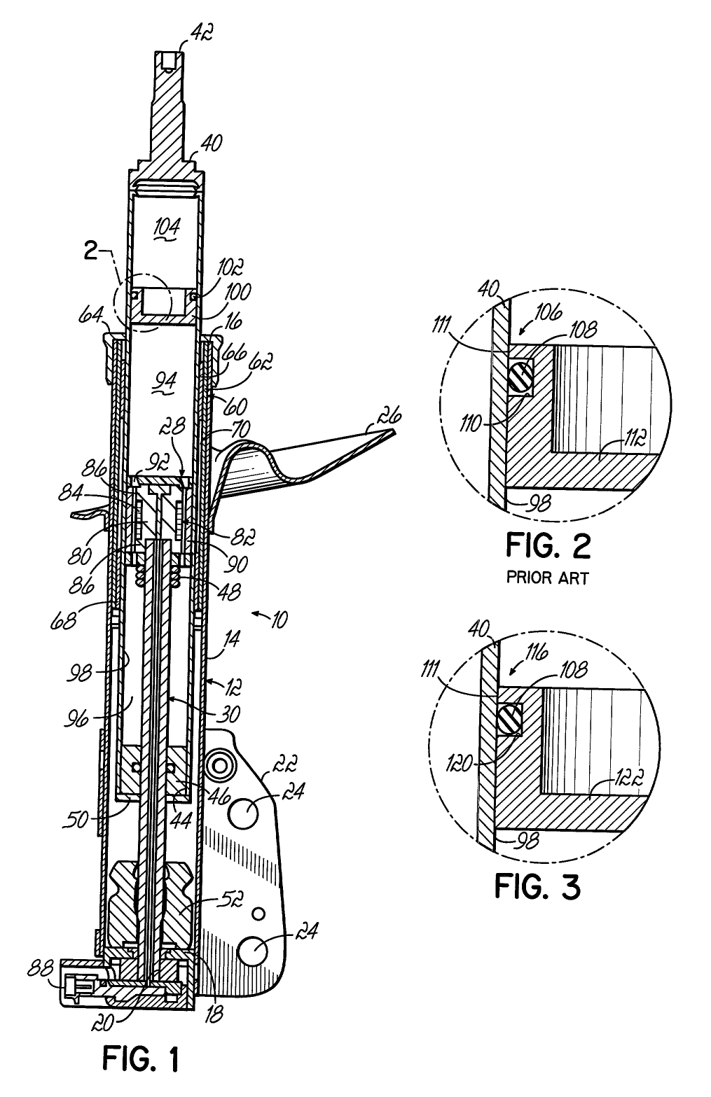

FIG. 1 illustrates a linearly-acting magneto-rheological (MR) fluid damper and in particular, a monotube gas-charged suspension strut 10. In general, the strut 10 is designed for operation as a load-bearing and shock-absorbing device within a vehicle suspension system and is connected between the sprung (body) and unsprung (wheel assembly) masses (not shown). The strut 10 comprises a housing 12 that includes a housing tube 14 with an open end 16 and a closed end 18. The closed end 18 includes an opening 20. A mounting bracket 22 near closed end 18 is secured in position by a suitable means such as welding. The mounting bracket 22 has suitable openings 24 for connection to the unsprung mass of the vehicle at a location such as the steering knuckle (not illustrated). A spring seat 26 is also received on the housing tube 14 and is positioned as required by the particular application within which the strut 10 will operate. The spring seat 26 is fixed in position on the housing tube 14 by a suitable means such as welding.

A piston assembly 28 is connected to a hollow piston rod 30 and is fixed in position within the housing tube 14. The piston rod 30 extends through the opening 20.

The strut 10 further includes a damper body tube 40 that is slidingly received over the piston assembly 28. The damper body tube 40 includes a first end 42 at an outboard position adapted to be connected to the sprung mass of the vehicle and includes a second end 44 at an inboard position. The second end 44 is supported about the piston rod 30 by a rod guide assembly 46 that is fixed in position within the damper body tube 40. At maximum extension of the strut 10, a rebound bumper 48 on the bottom of the piston assembly 28 is compressed against the rod guide assembly 46 to cushion the deceleration of strut 10. At maximum compression of the strut 10, a bottom plate 50 at the second end 44 of damper body tube 40 is adapted to contact a jounce bumper 52 that comprises an elastomeric bushing and that is positioned against the closed end 18 of housing tube 14 and about the piston rod 30.

The predominate means of supporting the damper body tube 40 within the housing tube 14 is provided by a bearing system 60. The bearing system 60 includes a bearing sleeve 62 slip-fit near the open end 16 of the housing tube 14. The bearing sleeve 62 is maintained in position by a retaining cap 64 that is pressed onto the open end 16 of housing tube 14. The bearing assembly 60 also includes a pair of plain bearings 66, 68 that are pressed into the bearing sleeve 62 and bear against the damper body tube 40. This provides a fluid-tight chamber 70 between the bearings 66, 68 which is filled with a lubricating oil.

The piston assembly 28 inside the damper body tube 40 includes a piston core 80 mounted on one end of piston rod 30 and formed of a magnetic material. The piston assembly 28 further includes a magnet assembly 82 including a coil 84 mounted on piston core 80 to form flux pole pieces 86 positioned on each axial end of the coil. The coil 84 is connected to an electrical source (not shown) via an electrical connector 88 extending through piston rod 30. The magnet assembly 82 also includes an annular flux ring 90 positioned around piston core 80 to form an annular flow gap 92 between the inner annular surface of the flux ring 90 and the outer surface of piston core 80 and coil 84. The piston assembly 28 divides the volume of MR fluid within the damper body tube 40 into a compression chamber 94 and an extension chamber 96.

Fundamentally, during damping, magneto-rheological (MR) fluid present in one of the chambers 94, 96 of damper body tube 40 flows through flow gap 92 from, for example, extension chamber 96 to compression chamber 94, as the damper body tube 40 moves upward. The flux ring 90 is designed with an outer diameter size to form a sliding fluid seal with a cylindrical inner surface 98 of damper body tube 14 so as to permit relative sliding movement while avoiding significant leakage at the interface.

The MR fluid within damper body tube 32 is a conventional MR fluid that has magnetic particles such as iron or iron alloys. The magnetic particles are controllably suspended within the fluid by controlling a magnetic field through the flow gap 60. Thus, a desired damping effect between the sprung and unsprung masses of the vehicle is achieved by controlling the application of an electric current to coil 50 in order to vary the magnetic field and hence, the flow characteristics of the MR fluid in the flow gap 60.

A gas cup 100 is also carried in the damper body tube 40 between the piston assembly 28 and the end of the damper body tube 40. The gas cup 100 carries a dynamic seal 102 and slides along the inner surface 98 of damper body tube 40, separating out a compensation chamber 104 from the compression chamber 94. While the extension chamber 96 and compression chamber 94 carry a supply of MR fluid, the compensation chamber 94 carries a compressible nitrogen gas supply. During extension and compression directed travel of the damper body tube 40 relative to the piston assembly 28, a decreasing or an increasing volume of the piston rod 30 is contained within the damper body tube 40 depending on the stroke position of the strut 10. In order to compensate for this varying volumetric amount of the piston rod 30 within the fluid-filled chambers 94, 96, the gas cup 100 slides, compressing or expanding the compensation chamber 104. In some applications, the compensation chamber 104 may contain pressurized air rather than nitrogen. In addition, the pressurized air may be provided by an onboard air compressor to compensate for changes in vehicle weight.

Referring to FIG. 2, a generally known dynamic seal 106 is shown as an O-ring 108 disposed in an annular O-ring groove 110 on an outer circumferential surface 111 of a gas cup 112. A desirable characteristic of an O-ring is that it rolls slightly within the O-ring groove as the gas cup begins to move. This roll reduces the breakout friction of the gas cup and enhances performance at low vibration levels. Standard engineering references for O-rings recommend a desired amount of “free roll room” for an O-ring of a particular size. Free roll room is an O-ring groove width in excess of the nominal free, or uncompressed, O-ring cross-section. Actual roll room is a little less because the O-ring compresses slightly when it is installed. The National O-ring Handbook recommends dimensions that give 19% free roll room, and the Wynn's Precision Handbook recommends dimensions that give 12% free roll room.

In some known applications, an MR fluid damper uses an O-ring having a diameter of 36 mm in an annular gas cup groove with 25% free room roll. In other MR fluid damper applications, an O-ring having a diameter of 46 mm is located in an annular gas cup groove with 15% free roll room. Thus, with reference to FIG. 2, the O-ring groove 110 has a width that is slightly larger, for example about 12%-25% larger, than the diameter of the O-ring 108. Thus, the free roll room allows the O-ring 108 to rotate slightly within the groove 110, thereby reducing breakout friction at low vibration levels. Also, the free roll of the O-ring 108 tends to lubricate the contact area with the inner surface 98 of the damper body tube 40 to also enhance durability of the O-ring 108 by reducing friction.

Although the dynamic seal 106 works for a period of time, it is desirable that the seal 106 have a longer service life and a service life that is comparable or better than other components of the MR fluid damper. For example, it is desirable that an MR fluid damper have a service life of 10 years and perform millions of strokes without significant leakage past the dynamic seal 106. A typical leakage criteria is 13 cc of MR fluid during the service life of the strut 10. Excessive leakage causes the gas cup 112 to distend into the compression chamber 94 until failure of the strut 10 occurs. Experience with the known dynamic seal 106 has proven that it falls far short of the above desired performance criteria.

It is believed that the limited service life of the dynamic seal 106 is related to the recommended and commonly used free roll room within the groove 110 in which the O-ring 108 is located. The free roll room exposes a surface of the O-ring 108 to abrasive magnetic particles that are contained in the MR fluid within the damper body tube 40. The exposed surface is then returned to contact the cylindrical wall 98 along with entrapped particles, causing premature wear of the O-ring 108 and cylinder wall 98. Thus, it is believed that the abrasive magnetic particles in the MR fluid in combination with the free roll room of the O-ring 108 in the groove 110 is the primary cause of premature O-ring wear.

To reduce abrasion to the gas cup O-ring and cylinder wall, referring to FIG. 3, the present invention provides an improved gas cup dynamic seal 116. In particular, the dynamic seal 116 constrains the free roll of the gas cup O-ring 108 with a narrower O-ring groove 120 in a gas cup 122. In practice, the free roll room in the improved dynamic seal 116 is chosen to be approximately 50% of that previously used and less than the minimums recommended by the engineering standards handbooks. For example, the free roll room used with a 46 mm O-ring is reduced to 8%, the free roll room used with a 36 mm O-ring is reduced to 10.5%. Testing of O-rings with the lesser free roll room verified that an improved durability is achieved with the gas cup dynamic seal 116 without sacrificing a desirable level of breakout friction nor the economy of an O-ring. Specifically, the achieved durability results in less than 13 cc of MR fluid leaking past the gas cup O-ring 108 after reciprocating the MR fluid damper millions of times over a simulated service life of ten years.

The gas cup O-ring 108 is formed from Therban® specialty elastomer, available from Bayer Corporation of Akron, Ohio, that tolerates high temperature and MR fluid. In particular, Therban® specialty elastomer is a thermally resistant butadiene acrylonitrile rubber made by saturating hydrocarbon chains of nitrile rubber with hydrogen. This material is generically referred to as Hydrogenated Nitrile Rubber (HNBR).

In use, referring to FIG. 1, during extension and compression directed travel of the damper body tube 40 relative to the piston assembly 28, a decreasing or increasing volume of the piston rod 30 is contained within the damper body tube 40 depending on the stroke position of the strut 10. To compensate for the changes in volume caused by the motion of the piston, the gas cup 100 slides, compressing or expanding the compensation chamber 104. In that sliding motion, as shown in FIG. 3, the narrow groove 120 in the gas cup 122 limits the free roll of the O-ring 108. The limited free roll reduces the number of abrasive magnetic particles in the MR fluid that can become lodged between the O-ring 108 and the interior side wall 98 of the damper body tube 40.

The limited free roll of the O-ring in the gas cup of the present invention provides a dynamic seal that has a substantially improved and lengthened service life. The average service life of the gas cup seal is more comparable to the average service life of other components in the MR fluid damper 10; and thus, the average service life of the MR fluid damper 10 is also increased.

While the present invention has been illustrated by the description of embodiments thereof, and while the embodiments have been described in considerable detail, it is not intended to restrict or in any way limit the scope of the appended claims to such detail. Additional advantages and modifications will readily appear to those skilled in the art. For example, the gas cup 122 described herein has application to other linearly-acting MR fluid dampers, for example twin-tube struts and shock absorbers.

The invention in its broader aspects is, therefore, not limited to the specific details, representative apparatus and method, and illustrative examples shown and described. Accordingly, departures may be made from such details without departing from the spirit or scope of the general inventive concept.

Having described the invention, what is claimed is:

1. A magneto-rheological (“MR”) fluid damper comprising:
a closed damper body tube having a substantially cylindrical inner surface and containing an MR fluid with abrasive magnetic particles;
a gas cup having an outer surface and disposed within the damper body tube, the gas cup isolating the MR fluid from a gas in one end of the damper body tube while sliding within the damper body tube; and
a dynamic seal formed in the outer surface of the gas cup and in sealing contact with the inner surface of the damper body tube, the dynamic seal comprising:
a magneto-rheological fluid compatible O-ring, and
a narrow O-ring groove disposed in the outer surface of the gas cup, the narrow O-ring groove being sized to reduce entrapment of abrasive magnetic particles in the MR fluid between the O-ring and the inner surface of the damper body tube.

2. The MR fluid damper of claim 1 wherein the O-ring groove has a width equal to about 105-112% of a nominal cross section of the O-ring.

3. The MR fluid damper of claim 1 wherein the O-ring groove has a free roll room of about less than 12%.

4. The MR fluid damper of claim 1 wherein the O-ring groove has a free roll room of about 5-12%.

5. The MR fluid damper of claim 1, wherein the annular O-ring groove has a free roll room of about 8-10.5%.

6. The MR fluid damper of claim 1, wherein the O-ring has a cross-sectional diameter of about 36 mm and the O-ring groove has a free roll room of about 10.5%.

7. The MR fluid damper of claim 1, wherein the O-ring has a cross-sectional diameter of about 46 mm and the O-ring groove has a free roll room of about 8%.

8. The MR fluid damper of claim 1, wherein the magneto-rheological fluid compatible O-ring is formed from hydrogenated nitrile rubber.

9. The MR fluid damper of claim 8, wherein the hydrogenated nitrile rubber of the magneto-rheological fluid compatible O-ring comprises a thermally-resistant butadiene acrylonitrile rubber.
